(19) United States
(12) Patent Application Publication
(10) Pub. No.: US 2019/0363366 A1
(43) Pub. Date: Nov. 28, 2019

(54) GRAPHENE-BASED COATING ON LEAD GRID FOR LEAD-ACID BATTERIES

(71) Applicant: XG SCIENCES, INC., 3101 Grand Oak Drive, MI (US)

(72) Inventors: Hiroyuki FUKUSHIMA, Okemos, MI (US); Thomas Griffin Ritch, East Lansing, MI (US); Liya Want, Ann Arbor, MI (US)

(21) Appl. No.: 16/530,197

(22) Filed: Aug. 2, 2019

Related U.S. Application Data
(63) Continuation-in-part of application No. 15/446,335, filed on Mar. 1, 2017, now Pat. No. 10,388,964.
(60) Provisional application No. 62/303,612, filed on Mar. 4, 2016.

(51) Int. Cl. H01M 4/66; H01M 4/73; H01M 10/06; H01M 4/22; H01M 4/04

(52) U.S. Cl. CPC H01M 4/663; H01M 4/73; H01M 4/0404; H01M 4/667; H01M 4/22; H01M 10/06

(57) ABSTRACT

A surface coating for application to the surface of lead-grids for lead-acid batteries includes a resin and a carbon material of graphene, graphene nanoplatelets, or a combination thereof, wherein the surface coating is configured to be applied to either electrode of the lead-acid battery. The surface coating providing both a protective coating to prevent corrosion of either or both of the positive and/or negative lead grids and a flexible buffer coating to reduce delamination at the interface of either or both of the positive and/or negative lead grids and the active paste.

### RELATED APPLICATIONS

This application is a continuation in part of U.S. Utility application Ser. No. 15/446,335 filed Mar. 1, 2017, now U.S. Pat. No. ______; that in turn claims priority benefit to U.S. Provisional Application Ser. No. 62/303,612 filed Mar. 4, 2016; the contents of which are hereby incorporated by reference.

### BACKGROUND OF THE INVENTION

The instant invention deals with graphene-based surface coatings on lead grids for lead-acid batteries to improve the adhesion between the grids and active material pastes, and to reduce the corrosion of the grids. The objective is to improve the performance and life of lead-acid batteries.

Lead-acid batteries (PbA) are one of the most widely used rechargeable batteries in the world, especially for automotive and uninterruptible power supply applications. Traditionally, automotive lead-acid batteries are mostly used for starting, lighting, and ignition (SLI). Such batteries can withstand frequent shallow charging and discharging, but, repeated deep discharges will result in capacity loss and premature failure, as the electrodes disintegrate as a result of mechanical stresses caused by deep cycling.

Additionally, starting batteries kept on continuous float charge tend to have corrosion in the electrodes which will result in premature failure. For some other applications such as UPS, forklifts, etc., lead-acid batteries are designed for deep charge and discharge, but at limited number of cycles. These batteries have low peak currents. Lead-acid batteries have been a relatively mature technology and have been in service for over 100 years.

In recent years, lead-acid batteries have received a lot of attention due to their new potential applications. One of them is in stop-start or micro-hybrid electric vehicles. In such automobiles, the stop-start system automatically shuts down and restarts the internal combustion engine to reduce the amount of time the engine spends idling, thereby reducing fuel consumption and emissions. This is most advantageous for vehicles which spend significant amounts of time waiting at traffic lights or frequently come to a stop in traffic jams. The stop-start function will significantly improve the fuel efficiency and reduce the tailpipe pollution. The traditional lead-acid batteries are attractive for such applications due to their low cost.

Current lead-acid batteries do not meet the performance targets under the cycling conditions of micro-hybrids. There are several major hurdles that need to be overcome. For example, the negative electrode tends to degrade due to the progressive accumulation of PbSO4 under partial state-of-the-charge, high current, and shallow depth-of-discharge.

Other major failure modes are the corrosion of lead grids and delamination of the active material paste from the grids. Both will increase the impedance of the battery and even lose the structure support for the electrode plates. This invention is related to resolving the problems associated with the lead grids.

Lead grids are used as the current collectors and support on which an electrode paste is coated to form a positive or negative plate. For automotive batteries, the positive and negative grids are often designed and manufactured in different forms due to the fact that they are subjected to different electrochemical environments and suffer different types of corrosion and at different levels. The grid surface corrosion is one of the main failure mechanisms for lead-acid batteries.

The corrosion reduces the adhesion between the grid and the active material. When the grid is no longer able to provide structure support and current flow, the battery fails. Therefore, improving the adhesion between the lead grid and paste mixture and reducing corrosion of the grid is one of the key approaches to enhance the performance and extend the life of a lead-acid battery. This is even more important for the stop-start type of applications where frequent, high current, and deep charge and discharge are all needed at different times.

Several methods have been developed to improve the adhesion between lead grid and the active material. For example, a layer of tin, lead-antimony, lead-silver, or lead tin alloy has been coated on the surface of lead-calcium grid to improve the adhesion and protection. Similar surface layers have also been applied by roll-bonding or fusing to the grid.

Chinese patent CN101969143 discloses a method for preparing a nano high-energy maintenance-free lead-acid battery which includes a step of forming superfine glass fiber layers on the surfaces of grids made of a nano ceramic powder and lead metal powder material.

Chinese patent CN201877504 relates to a lead grid consisting of a conducting material layer and a composite material layer. The composite material layer consists of one of lead or lead alloy coating layer, a foam lead layer and an acid-resistant coating layer. The two sides of the conducting material layer are coated with the lead or lead alloy coating layer on which an acid-resistant coating layer is coated. The conducting material layer in the middle of the plate grid serves as a current transmitting passageway so that the resistance is greatly reduced, and the current distribution is more even.

Chinese patent CN10270952 discloses a method for preparing lead-acid battery positive electrode plate that includes the steps of: preparing a positive electrode grid body, conducting electrochemical surface modification of the lead alloy positive grid body, post-treatment of the modified surface of the positive lead alloy grid, and washing and drying of the resulting rare earth modified lead alloy surface of the positive grid.

Chinese patent CN104821402 uses a surface roughening method to improve the adhesion between lead grids and active pastes. The method is mainly characterized by carrying out a plate grid surface roughening treatment, wherein a roughening treatment is performed on the surface of the continuous plate grid framework structure. According to the invention, the bonding force of the punching plate grid and the lead paste can be improved and the method is especially suitable for production of the high-power storage battery punching plate grid.

Chinese patent CN104362301 discloses a preparation method for a carbon coated titanium-based lead dioxide positive plate which is obtained by coating a carbon material on the surface of a metallic titanium mesh with a vapor deposition method.

There are other methods to improve the grid performance in lead-acid batteries. For example, lead-carbon, including lead-graphene and lead-graphite, composites have been tested as possible positive current collectors for lead-acid batteries. It has been shown that neither graphene nor graphite participate in the electrochemical process but they improve corrosion and electrochemical characteristics of both metallic composite materials. No products of interaction of lead with sulfuric acid were formed on the surface of graphene and graphite. Graphene inclusions in lead prevent formation of ready oxide nanocrystals which deteriorate discharge characteristics of positive electrode of lead-acid batteries. Preparation of lead-graphene or lead-graphite composite, however, was performed in molten alkali halides media, thereby increasing the processing complexity and cost.

### BRIEF DESCRIPTION OF THE INVENTION

A surface coating for the surface of lead-grids for lead-acid batteries wherein the coating comprises a resin, a material selected from the group consisting of i. graphene and ii. graphene nanoplatelets.

### DETAILED DESCRIPTION OF THE INVENTION

The instant invention provides a graphene-based coating for application on lead-grids for lead-acid batteries. That is, embodiments of the inventive graphene-based coating are suitable for application on either or both of a positive and negative electrode of a lead-acid battery. According to embodiments, the invention provides graphene-based ink formulations that can be applied to the surface of lead-grids to improve adhesion between the grids and the active materials and to prevent the corrosion of the grids.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments of the present disclosure, an inventive surface coating includes a resin and a carbon material. The carbon material of an inventive surface coating is graphene, graphene nanoplatelets, or a combination thereof. Properties of the graphene and graphene nanoplatelets provide several advantages for embodiments of the inventive surface coating. First, the graphene and graphene nanoplatelets are electrically conductive and do not hinder the current flow between the positive or negative lead grid and the active paste. According to embodiments, the graphene or graphene nanoplatelets used in embodiments of an inventive surface coating have a conductivity of approximately 3,000 S/cm or 300,000 S/M. Second, graphene and graphene nanoplatelets have a good barrier property with a thin, high aspect ratio, and 2-dimensional morphology, which helps prevent the lead grid from being in contact with the electrolyte of the lead-acid battery. Given that reaction of lead with water to form lead oxide and hydrogen gas is the main corrosion mechanism for a lead-grid, the barrier properties of graphene and graphene nanoplatelets in embodiments of the inventive surface coating reduces corrosion of the positive and/or negative lead-grids, thereby extending the life and performance of lead-acid batteries.

Embodiments provide a relatively soft but robust surface coating with high surface area graphene or graphene nanoplatelet fillers. Delamination at the interface of the lead-grid and the active paste is another major reason for lead-acid battery failure, given that when delamination occurs, the grid does not provide enough structural support for the electrode plate. The inventive surface coating helps improve adhesion between the positive and/or negative lead grid and the active paste. That is, the inventive surface coating for either or both of the positive and/or negative lead grids of a lead-acid battery acts as a buffer layer between either or both of the positive and/or negative lead grids and the active paste of the lead-acid battery. Thus, the inventive surface coating is both a protective coating to prevent corrosion of either or both of the positive and/or negative lead grids and a flexible buffer coating to reduce delamination at the interface of either or both of the positive and/or negative lead grids and the active paste.

As noted above, the carbon material of the inventive surface coating is a single layer graphene, a multi-layer graphene, graphene nanoplatelets, or a combination thereof. According to embodiments, graphene nanoplatelet is employed due to its low cost and easy-handling nature as compared to single layer graphene. The thickness and size of graphene or graphene nanoplatelets can be adjusted to meet the processing, coating quality, and battery performance needs. According to embodiments, the single layer graphene, multi-layer graphene, or graphene nanoplatelets have a thickness from 0.3 nm to 100 nm and a diameter from 0.1 microns to 100 microns. In addition to graphene or graphene nanoplatelet, other additives may be added in the formulation to provide different properties and functionalities. Such additives include but are not limited to graphite, carbon black, carbon fibers, carbon nanotubes (CNT), carbon fiber, metallic or ceramic flakes or particles.

As noted above, embodiments of the inventive surface coating include at least one acid-resistive resin which serves as a binder. The resin may be selected from polycarbonates, polysulfones, polyphenylene sulfide (PPS), fluoropolymers, phenolic resins, epoxies, urethanes, acrylonitrile butadiene styrene (ABS), polystyrene, polyolefins, and copolymers of the polymers set forth just above, among others. They can be used individually or in combination to form a multi-resin system.

According to embodiments, the surface coating when dry contains between 1 wt % and 50 wt % carbon materials, and between 99 wt % and 50 wt % polymer resin. According to embodiments, the amount of polymer resin present in the coating results in the coating being non-permeable to acid, while also providing a sufficient amount of conductive filler or carbon materials to provide the desired electrical conductivity as well as barrier properties. According to embodiments, the conduction or functional filler is carbon nanotube (CNT), carbon filler, or a combination thereof. According to embodiments, the electrical conductivity of the surface coating for either or both of the positive and/or negative lead grids of a lead-acid battery is 1000-3500 S/M.

The present disclosure also provides methods for applying embodiments of the inventive surface coating onto either or both of the positive and/or negative lead grids of a lead-acid battery. According to embodiments, the resin is dissolved in a proper solvent to form a slurry or ink. Depending on the resin system, the solvent is cyclopentanone (cyclic ketone), propiophenone (aryl ketone), anisole, tetrahydrofuran (THF), N-Methylpyrrolidone (NMP), dimethyl sulfoxide (DMSO), dimethylformamide (DMF), toluene, xylene, dichlorobenzene, alcohols, ketones, or water. Graphene and/or graphene nanoplatelets, together with other additives are mixed with the resin and solvent to form a slurry or ink. The coating is then applied onto the either or both of the positive and/or negative lead grids of a lead-acid battery by a method selected from the group including dip coating, spray coating, roller coating, brush coating, and other conventional coating methods.

According to embodiments, polysulfone resin is dissolved in an appropriate solvent such as tetrahydrofuran. A conductive carbon blend containing graphene nanoplatelets is dispersed into the polymer solution by high shear mixing to form an ink. Either or both of the positive and/or negative lead grids of a lead-acid battery are then dip coated in this ink such that they are entirely covered in a uniform, continuous coating with a thickness of less than 30 microns. The lead-grids are then transferred to a drying oven to remove residual solvent.

The primary attributes of this coating include: The coating is totally resistant to attack by sulfuric acid in any conditions encountered by a lead acid battery during normal use conditions; The materials are electrochemically non-reactive in a PbA system; The coating does not allow acid to reach or corrode the underlying current collector; The coating is sufficiently electrically conductive that the underlying current collector continues to function normally; The coating is thin but the coverage is complete; The coating has strong adhesion to lead and does not delaminate during electrochemical cycling; This coating can be simply applied to existing PbA current collectors without the need for specialized equipment.

### EXAMPLES

The present invention is further detailed with respect to the following non limiting examples. These examples are not intended to limit the scope of the invention but rather highlight properties of specific inventive embodiments and the superior performance thereof relative to comparative examples.

| Material | wt % |
|---|---|
| Tetrahydrofuran | 90.00% |
| Polysulfone | 5.00% |
| xGnPR7 (*) | 3.75% |
| Super C 65 carbon black | 1.25% |
| Total | |

Procedure

| | |
|---|---|
| 1 | Dissolve polysulfone pellets in |
| | tetrahydrofuran |
| 2 | Stir R7 and carbon black into the |
| | polymer solution |
| 3 | Disperse using rotor stator high shear |
| | mixer, 900 RPM for 2 minutes |
| 4 | Let sit for several hours to degas |

(*) xGnPR7 sample used herein had a surface area of around 50 m2/g with the average flake thickness around 17.5 nm. The mean particle size of the xGnPR7 sample was about 7 μm, and the aspect ratio of the sample was about 400. xGnP is a trademark owned by Xg Sciences, Lansing, Michigan. xGnP ™

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A surface coating for the surface of lead-grids for lead-acid batteries wherein the coating comprises at least one resin and a carbon material selected from the group consisting of: graphene and graphene nanoplatelets.
wherein the surface coating is configured to be applied to either electrode of the lead-acid battery.

2. The surface coating as claimed in claim 1 wherein, in addition, there is also present a functional filler.

3. The surface coating as claimed in claim 1 wherein the carbon materials are single-layer graphene, multiple-layered graphene, graphene nanoplatelets, with a thickness from 0.3 nm to 100 nm and a diameter from 0.1 microns to 100 microns.

4. The surface coating as claimed in claim 3 wherein the carbon materials have a thickness from 1 nm to 30 nm and a diameter from 1 to 10 microns.

5. The surface coating as claimed in claim 1 wherein the lead-grid is made of lead or lead-based alloys containing lead and one or more alloy elements selected from the group consisting of calcium, antimony, tin, silver, and selenium.

6. The surface coating as claimed in claim 1 wherein the lead-grid is made of lead-carbon composite comprised of lead or lead-based alloys with one or more carbonaceous reinforcement materials selected from the group consisting of carbon black, graphite, carbon fibers, carbon nanotubes, graphene, or graphene nanoplatelets.

7. The surface coating as claimed in claim 1 wherein the resin is one or more polymers selected from the group consisting of polycarbonates, polysulfones, polyphenylene sulfide (PPS), fluoropolymers, phenolic resins, epoxies, urethanes, acrylonitrile butadiene styrene (ABS), polystyrene, polyolefins, and copolymers of polymers set forth just above.

8. The surface coating as claimed in claim 1 wherein one or mere functional additives are selected from the group consisting of carbon blacks, graphite, carbon fibers, fullerenes, carbon onions, carbon flowers, carbon nanofibers, carbon nanocaps, vapor grown carbon fibers or carbon nanotubes.

9. The surface coating as claimed in claim 1 wherein one or more functional additives are selected from the group consisting of metallic particles, fibers, nanotubes, and flakes.

10. The surface coating as claimed in claim 1 wherein one or more functional additives are selected from the group consisting of ceramic particles, fibers, nanotubes, and flakes.

11. The surface coating as claimed in claim 1 wherein said composition contains 1-50 wt % of carbon materials based on the weight of the total composition.

12. The surface coating on lead-grids for lead-acid batteries as claimed in claim 1 wherein the coating has a thickness in the range of 1 to 1000 microns. The surface coating on lead-grids for lead-acid batteries as claimed in claim 15 wherein the coating has a thickness in the range of 1 to 50 microns.

13. A method of coating lead-grid with a composition as claimed in claim 1 wherein a slurry or ink of the composition is applied by a method selected from the group consisting of dip coating, spray coating, roller coating, printing, or brush coating.

14. A method of coating lead-grid with a composition as claimed in claim 1 wherein said composition is applied to said lead-grid wherein the composition is prepared by dissolving a resin in a solvent and mixing the carbon material and functional additives into the resin solution by a method selected from the group consisting of mechanical stirring, shearing, or milling.

15. The method as claimed in claim 14 wherein the solvent is selected from the group consisting of cyclopentanone (cyclic ketone), propiophenone (aryl ketone), anisole, tetrahydrofuran (THF), N-Methyl-pyrrolidone (NMP), dimethyl sulfoxide (DMSO), alcohols, ketones, and water.
